(19) United States
(12) Patent Application Publication
(10) Pub. No.: US 2023/0123537 A1
(43) Pub. Date: Apr. 20, 2023

(54) Truss, Arched Structure And Shed

(71) Applicant: TOPICO LOCACOES DE GALPOES E EQUIPAMENTOS PARA INDUSTRIAS S.A., Embu das Artes (BR)

(72) Inventor: Fernando De Morais Gomez, Caieiras (BR)

(21) Appl. No.: 17/802,929

(22) PCT Filed: Jan. 19, 2021
(86) PCT No.: PCT/BR2021/050025

§ 371 Date: Aug. 26, 2022

(30) Foreign Application Priority Data
Mar. 2, 2020 (BR) 102020004188-6

(51) Int. Cl. E04B 1/24; E04B 1/342

(52) U.S. Cl. CPC E04B 1/24; E04B 1/342; E04B 2001/246; E04B 2001/2493

(57) ABSTRACT

The present invention relates to a truss that allows the formation of an arc when connected with other trusses and that creates an optimal angle that generates a lower calculation effort in the structure.

The present invention also relates to an arched structure comprising a plurality of such trusses and to a shed comprising a plurality of arched structures.

### FIELD OF THE INVENTION

The present invention relates to a truss that allows the formation of an arc when connected with other trusses and that creates an optimal angle that generates a lower calculation effort in the structure.

The present invention also relates to an arched structure comprising a plurality of such trusses and to a shed comprising a plurality of arched structures.

### BACKGROUND OF THE INVENTION

Structures such as arched sheds are well known from the prior art. Current dynamics require that such structures are capable of being built quickly and efficiently, and prefabricated parts are commonly used to assemble the shed.

The state of the art describes various solutions for assembling arched sheds from individual parts, for a wide variety of applications, such as greenhouses and storage. One can cite documents CN 102715037, CN 106105881, CN 106321118 and CN 107524315 as representative of the prior art for arched sheds.

The present invention differs from these solutions by presenting a shed formed by several trusses that provide an optimal angle for the fabrication of the arch, minimizing the efforts on the structure.

Therefore, the present invention is innovative in face of the current state of the art and even if an expert combined these teachings, the solution proposed by this invention would not be reached.

### SUMMARY OF THE INVENTION

It is an object of the present invention a truss that allows the formation of an arch when connected with other trusses.

In a preferred realization, the truss comprises:

a) an upper beam;

b) a bottom beam;

c) means for connection to another truss and/or a side column;

wherein the lower beam has a shorter length than the upper beam so as to generate an angle of 2° to 15° when another truss is connected at one of its lateral ends.

The truss further comprises angled beams connecting the upper beam to the lower beam, wherein the angle formed by the angled beam with the lower beam is 40° to 50°.

Preferably, the angle generated when two trusses are connected by their side ends is 8°, and the angle formed by the angled beam with the lower beam is 43° to 46°.

It is an additional object of the present invention an arched structure comprising two corner trusses connected to each other by a plurality of middle trusses, and side columns connected to the corner trusses.

It is an additional object of the present invention to provide a shed comprising a plurality of arched structures connected by means of cross bars.

### BRIEF DESCRIPTION OF THE FIGURES

FIG. 1 shows the middle truss in detail.

FIG. 2 shows the corner truss in detail.

FIG. 3 shows the connection detail between middle trusses.

FIG. 4 shows the detail of the connection between the corner truss and the side column.

FIG. 5 shows the detail of the eye for fixing the bracing steel cable.

FIG. 6 shows the lateral column in details.

FIG. 7 shows the front column in details.

FIG. 8 shows the column-column link in detail.

FIG. 9 shows the arch formed by the middle truss connection.

FIG. 10 shows the union between the middle trusses, corner trusses and the side column, anchored to the foundation.

FIG. 11 shows a front view of the arch structure.

FIG. 12 shows a front view of the arch structure comprising front columns.

FIG. 13 shows a front view of the shed comprising a plurality of arched structures.

FIG. 14 shows a side view of the shed, comprising a plurality of arched structures.

FIG. 15 shows an isometric view of the shed, comprising a plurality of arched structures.

FIG. 16 shows the connection of the cross bars in details.

### DETAILED DESCRIPTION OF THE INVENTION

The following description is intended only to exemplify some of the numerous ways in which the invention can be embodied and should not be viewed as limiting the scope of the present invention.

Trusses

The truss according to the present invention comprises:

a) an upper beam;

b) a bottom beam;

c) means for connection to another truss and/or a side column;

wherein the lower beam has a shorter length than the upper beam so as to generate an angle of 2° to 15° when another truss is connected at one of its lateral ends.

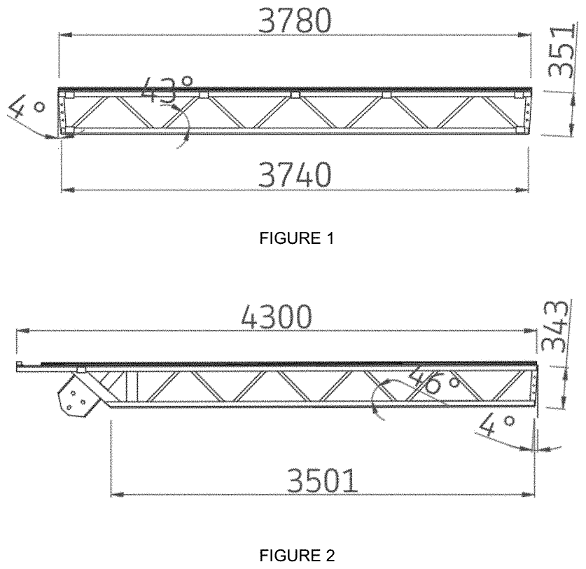

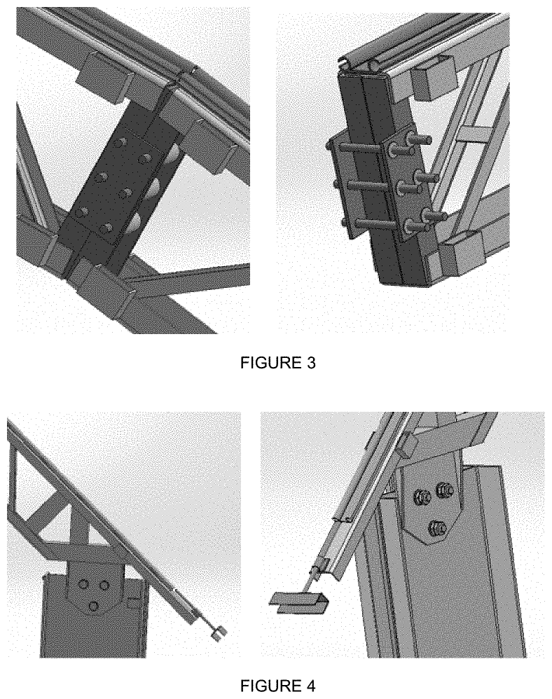

The present invention describes two types of trusses: a corner truss (FIG. 2), wherein one end connects to a side column and the other end connects to another truss; and a middle truss (FIG. 1), wherein both ends connect to other trusses.

During the development of the trusses, an “optimal” angle was adopted that could generate the lowest possible calculation effort and the highest possible repetition of these elements. As can be seen in FIGS. 1 and 2, the shorter length of the bottom beam generates a preferential (optimal) angle of 4° in each truss, and when the trusses are connected, the total angle is the sum of the angles of each truss. Thus, when connecting two trusses, a preferential angle formed between them will be 8°.

The truss further comprises angled beams connecting the top beam to the bottom beam, wherein the angle formed by the angled beam with the bottom beam is 40° to 50°. FIGS. 1 and 2 show how the angled beams are arranged along the truss, and their preferred angles.

Preferably, the angle generated when two trusses are connected by their side ends is 8°, and the angle formed by the angled beam with the bottom beam is 43° to 46°.

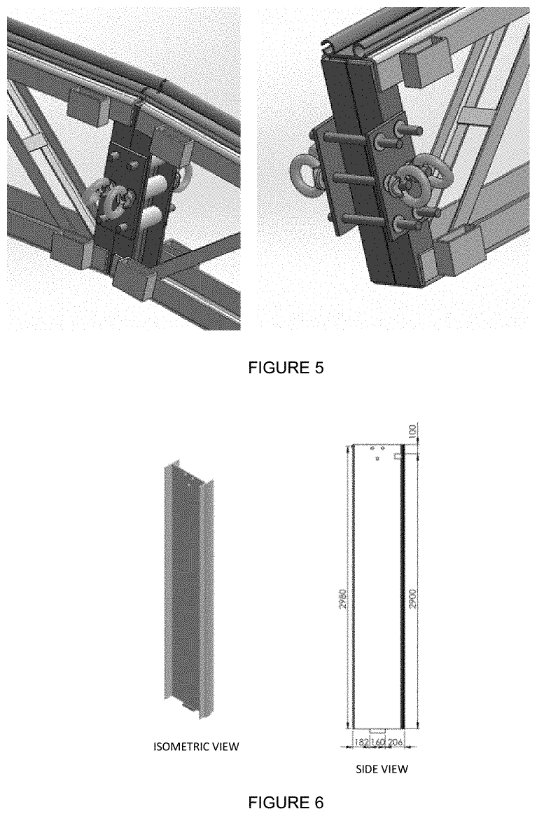

In an alternative embodiment of the present invention, the means for connecting to another truss have means for connecting bracing cables. The bracing cables are designed to be connected directly to the connections between trusses, thereby reducing structural elements in manufacturing production without impacting assembly. Examples of these connection means are shown in FIG. 5.

Trusses further comprise means for connecting crossbars. The crossbars are structures that connect the arch structures, giving the shape of the shed. An example of a means for connecting crossbars can be seen in FIG. 16.

Trusses also have means for connecting front columns, which allow better support of the arch generated by connecting several middle trusses.

Besides the issue of the quantity of different pieces, the trusses have a maximum weight of 92 kg so that 04 people can carry them, with ergonomic comfort, without the help of mechanical equipment, thus reducing the assembly costs.

All the trusses are assembled on the ground and lifted with a munck truck, thus reducing the number of steel cables supporting the pillars and decreasing the use of platforms in the field.

The connections between trusses were developed to be connected on the sides of the trusses, thus facilitating the use of screwing machines to tighten the bolts, thus increasing the productivity of the assembly.

Arch Structure

The arched structure is the structure formed by two corner trusses, a plurality of middle trusses, and side columns. Specifically, the arch structure comprises two corner trusses connected to each other by a plurality of middle trusses, and side columns connected to the corner trusses. An example of the arch assembly is shown in FIG. 11. The side columns connected to the corner trusses may be connected to the building foundation or to another side column segment in order to increase the column height of the arch structure. An example of one type of side column connection is shown in FIG. 8.

The side columns are commercially available profiles (W530×72) with multiple sizes of the dimensions sold in the market and require little fabrication work, only drilling and welding of small elements.

Besides having the best shape for storage in the trailer for transport to the site.

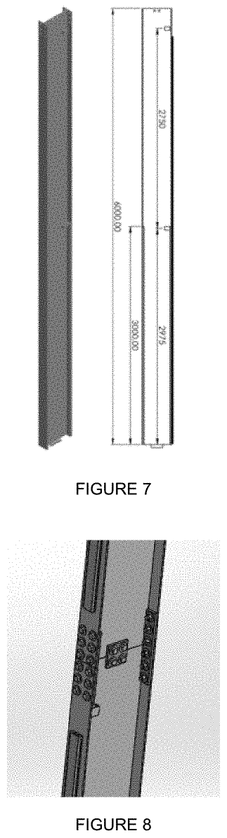

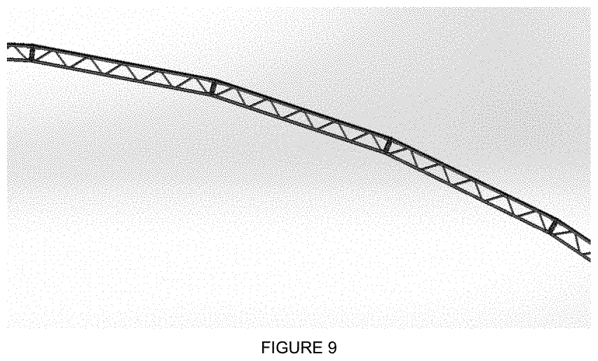

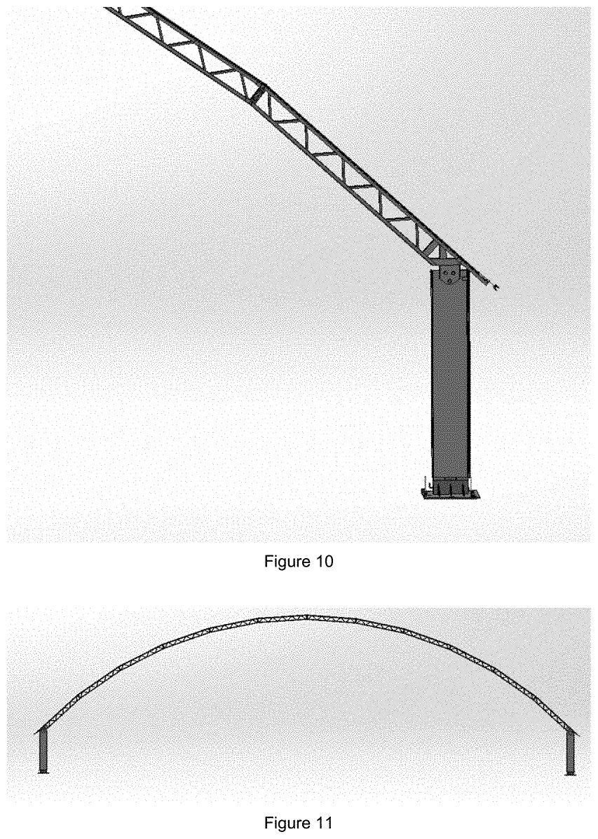

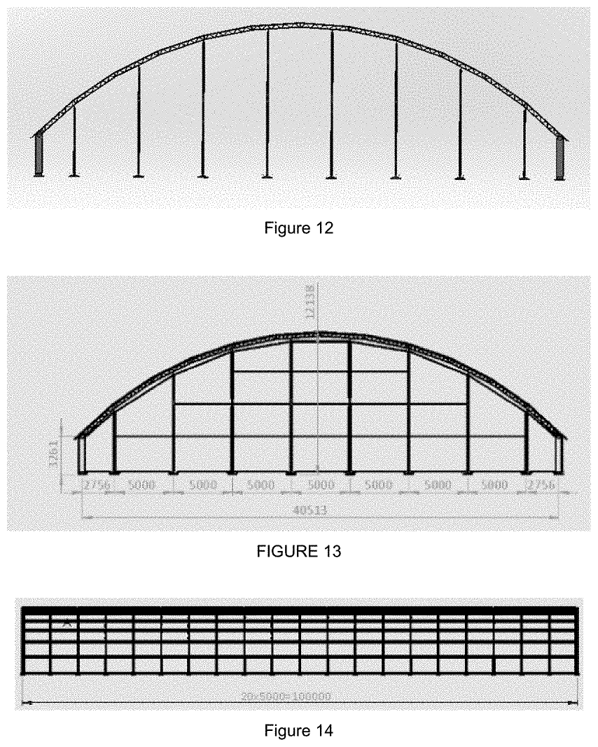

The arch structure can also be supported by front columns, connected to the middle trusses by means of connecting to front columns. An example of a front column is shown in FIG. 7. Like the side columns, the front columns can also connect to another front column segment in order to increase the column height of the arch structure. Example of one type of front column connection is shown in FIG. 8.

The front columns are easily purchased commercial profiles (W410×38.8) with multiple sizes of the dimensions sold in the market, reinforced with plates of commercial sizes and require little fabrication work.

Besides having the best shape for storage in the trailer for transport to the construction site.

The front columns can also be connected to each other by means of horizontal crossbars. Examples of an arch according to the present invention containing said horizontal crossbars are shown in FIG. 13.

Shed

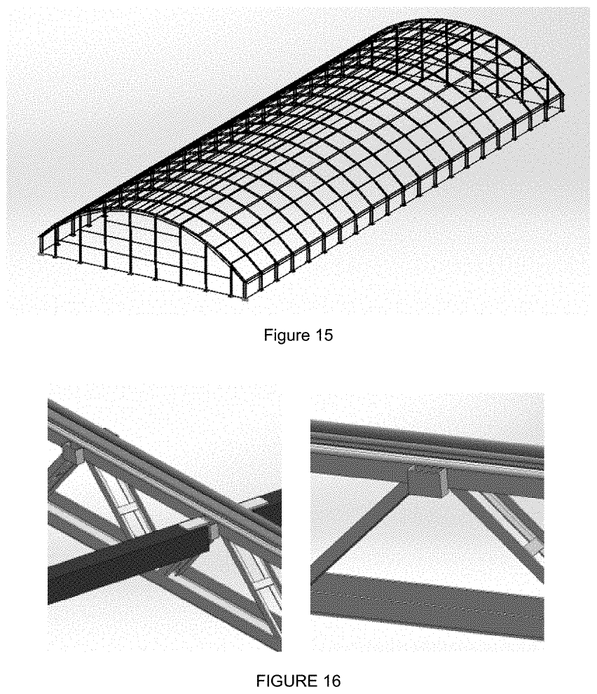

The shed according to the present invention comprises a plurality of arch structures arranged sequentially opposite each other, connected by horizontal crossbars, as shown in FIG. 16. The horizontal crossbars connect the arch structures to each other via the means for connecting crossbars present in the trusses. FIG. 14 shows a side view of a shed assembled in accordance with the present invention, showing the plurality of arch structures (vertical lines) and the crossbars connecting the arch structures (horizontal lines). FIG. 15 is an isometric view of a shed according to the present invention. Preferably, the crossbars are interconnected at the trusses and columns by means of cut tubes and no longer folded and welded sheets, this generates savings in manufacturing production.

In its final configuration the shed has in the shears only two different types of trusses, thus increasing manufacturing and assembly productivity.

The articulated connections cause the calculation efforts to be of less intensity in the elements of greater length (trusses) and of greater intensity in the elements of lesser length (columns), thus optimizing the cost of the shed.

The shed according to the present invention can be further covered by suitable materials, such as tiles or tarpaulins.

The installation of the roof tarpaulins is facilitated by the geometry of the arch, thus increasing the productivity of the field assembly. The front tarpaulins are installed with aluminum help along their entire length, eliminating the need for tarpaulins tied with ropes, reducing the number of cuts during their making and thus increasing the productivity of field assembly.

1. Truss characterized by comprising:
a) an upper beam;
b) a lower beam;
c) means for connection to another truss and/or a side column;
wherein the lower beam has a shorter length than the upper beam so as to generate an angle of 2° to 15° when another truss is connected at one of its lateral ends.

2. Truss, according to claim 1, characterized in that the generated angle is 8°.

3. Truss, according to claim 1, characterized in that it additionally comprises angled beams connecting the upper beam to the lower beam, wherein the angle formed by the angled beam with the lower beam is 40° to 50°.

4. Truss, according to claim 3, characterized in that the angle formed by the angled beam with the bottom beam is 43° to 46°.

5. Truss, according to claim 1, characterized by the means for connecting to another truss having means for connecting bracing cables.

6. Truss, according to claim 1, characterized in that it additionally comprises means for connecting crossbars and/or means for connecting to front columns.

7. Arch structure characterized in that it comprises two corner trusses connected to each other by a plurality of middle trusses, and side columns connected to the corner trusses, wherein the corner trusses and the middle trusses are as defined in claims 1 to 6.

8. Arched structure according to claim 7, characterized in that the side column is connected to another side column segment or to the building foundation.

9. Arched structure according to claim 7, characterized in that it comprises front columns connected in the trusses as defined in claims 1 to 6.

10. Arched structure according to claim 9, characterized in that it comprises horizontal crossbars connecting the front columns.

11. Shed characterized in that it comprises a plurality of sequentially arranged arch structures connected by horizontal crossbars.

12. Shed according to claim 11, characterized by the horizontal crossbars connecting the arch structures through the means for connecting crossbars present in the trusses.

13. Shed, according to claim 11, characterized by being covered.

14. Shed, according to claim 13, characterized by being covered by tarpaulins and/or tiles.
